(19) United States
(12) Patent Application Publication
(10) Pub. No.: US 2014/0008102 A1
(43) Pub. Date: Jan. 9, 2014

(54) TWISTED PAIR SPACER TAPE FOR USE IN LAN CABLE

(71) Applicants: Paul Kroushl, Lancaster, PA (US); Paul Vanderlaan, Landisville, PA (US)

(72) Inventors: Paul Kroushl, Lancaster, PA (US); Paul Vanderlaan, Landisville, PA (US)

(21) Appl. No.: 13/540,778

(22) Filed: Jul. 3, 2012

(51) Int. Cl. H01B 17/56

(52) U.S. Cl. 174/137 R

(57) ABSTRACT

A spacer for use in a twisted pair of electrical conductors said spacer includes a polymer strip and a series of openings in said polymer strip. The polymer strip is configured to be placed between two adjacent conductors of a twisted pair. The polymer strip and said series of openings are constructed so that the series of openings are not substantially crushed during a twinning process of twisting the adjacent conductors of the twisted pair.

### BACKGROUND

1. Field of the Invention

The present invention relates to the field of cables. More particularly, the present invention relates to a component for use in networking cables.

2. Description of Related Art

Communication cables are broadly grouped into two arrangements, fiber optic cables and metal conductor cables, each of which has their own unique set of construction parameters that affect the quality of the communication signals carried therethrough.

Regarding metal conductor cables, one typical arrangement is the LAN (Local Area Network) cable that is usually constructed of four pairs of twisted insulated copper conductors encased within a jacket. Other larger cables may employ more pairs of conductors.

In this typical four pair LAN cable construction, in addition to protecting against external environmental interferences, in order to decrease cross talk between signals passing through one pair, and signals passing through adjacent pairs within the same LAN cable, the pairs of conductors are twisted. Moreover, as the signal interference between pairs is highest when conductors of adjacent pairs He parallel to one another, pairs are twisted around one another at different rates (i.e. at different lay lengths) to minimize the instances of parallel conductors in adjacent pairs. Other items such as cross fillers may be added to even further reduce the amount of cross talk between pairs within the cable. See prior art FIG. 1 showing an exemplary cross filler in a four pair LAN cable.

A more recent prior art, U.S. Pat. No. 6,506,976 shows an alternative option that uses a single spacer element placed between two conductors forming each pair in the four pairs as shown in the prior art FIG. 2.

Another arrangement shown in prior art FIGS. 3 and 4 from U.S. Patent Publication No. 2009/0236120, uses a spacer between the pairs to improve electrical and mechanical performance of cable. The spacer in its basic form is a divider placed between the two conductors of the pair prior to twinning. After twinning, the spacer remains helically twisted with the conductors of the pair, between the two conductors, such that the outer surfaces of the insulated conductors are prevented from touching one another.

Such an arrangement is used for many purposes to improve electrical and mechanical performance of cable including, but not limited to, providing more conductor insulation options to control and/or reduce insertion loss, match impedance, reducing propagation delay and/or skew between twisted pairs, improving flexibility, reducing weight, reducing cable diameter and reducing smoke emitted in the event of a fire. In one arrangement, shown in prior art FIG. 4, the spacer may employ a hollow profile,

### OBJECTS AND SUMMARY

Although such twisted pair spacers in the prior art work to separate the conductors of a twisted pair, the current structure for such spacers tend to have too much material, and thus give little benefit relative to their difficulty in implementing/inserting. Additionally, with other shaped spacers, such as that shown in FIG. 4, the structure of the spacer is difficult to manufacture and, additionally, is not capable of retaining its shape and/or spacing function, during the crushing forces imposed during the twinning process.

The present arrangement overcomes certain drawbacks with the prior art arrangements and provides a twisted pair spacer for use in twisted pairs of a LAN cable that not only provides improved electrical characteristics versus a solid tape or film spacer noted in U.S. Pat. No. 6,506,976 (e.g., reduced insertion loss, reduced propagation delay, reduced delay/skew between pairs) but also offers improvements in terms of mechanical crush resistance versus hollow spacer elements mentioned in US Patent Publication No. 2009/0236120

For example, although prior art arrangements may in theory improve electrical properties of a cable, because of cable manufacturing line speeds and tensions, particularly in the process of “twinning” (twisting two conductors into a pair), such hollow spacers (e.g. prior art FIG. 4) attempting to create pockets of air between the conductors are crushed and/or deformed negating the effects of any airgaps. The present arrangement spacer is constructed so that the spacer makes use of open spaces that provide improved electrical characteristics, while simultaneously structuring the open spaces to be maintained during the twinning process and thus remain present in the final product.

To this end a spacer is provided for use in a twisted pair of electrical conductors where the spacer includes a polymer strip and a series of openings in the polymer strip. The polymer strip is configured to be placed between two adjacent conductors of a twisted pair. The polymer strip and series of openings are constructed so that the series of openings are not substantially crushed during a twinning process of twisting the adjacent conductors of the twisted pair.

### BRIEF DESCRIPTION OF THE DRAWINGS

The present invention can be best understood through the following description and accompanying drawings, wherein:

FIGS. 1-4 show prior art cross fillers and spacer elements;

FIG. 5 shows an exemplary LAN cable using the spacer element in accordance with one embodiment;

FIG. 6 shows an isolated spacer element in accordance with one embodiment; and

FIG. 7 shows a twisted pair with the spacer element of FIG. 5, in accordance with one embodiment.

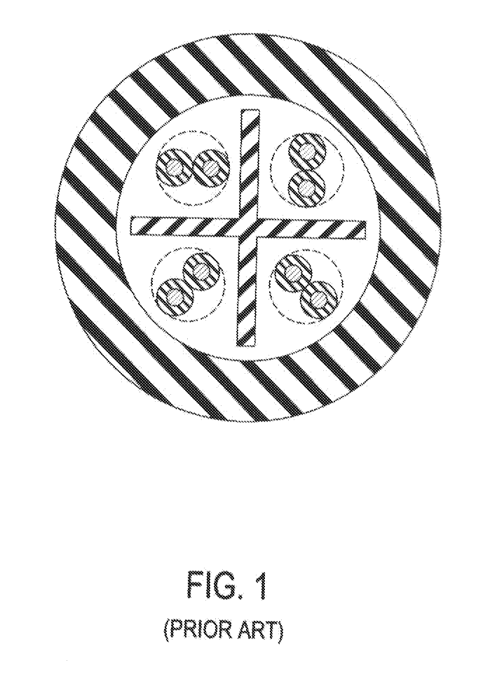

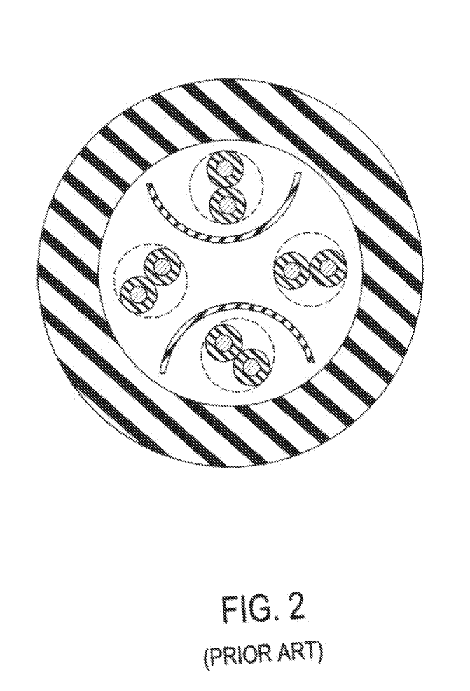

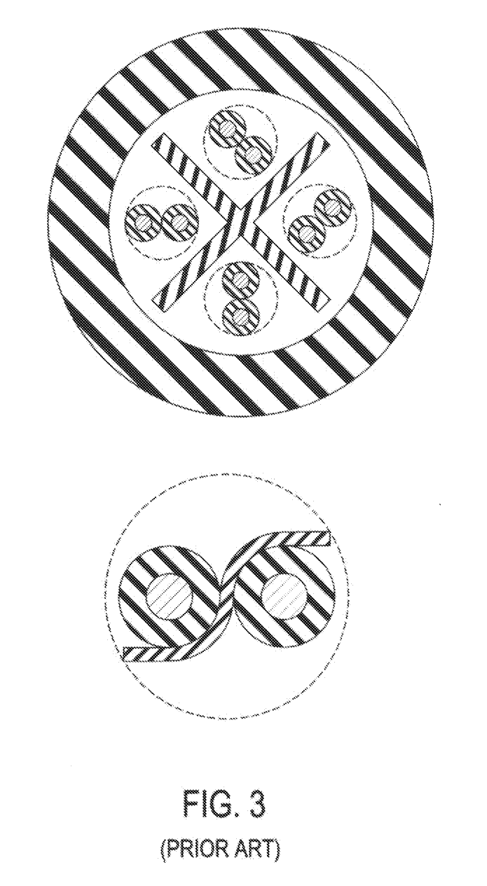

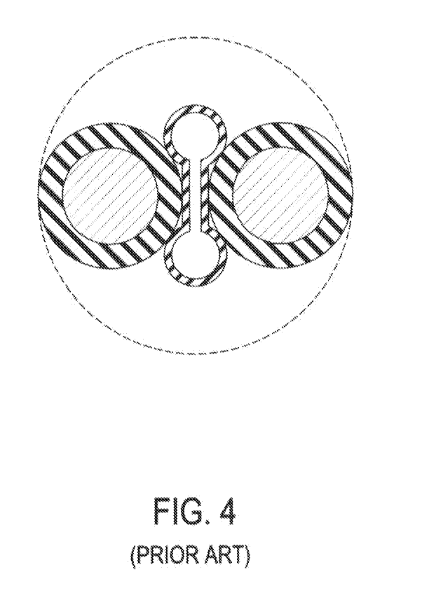

### DETAILED DESCRIPTION

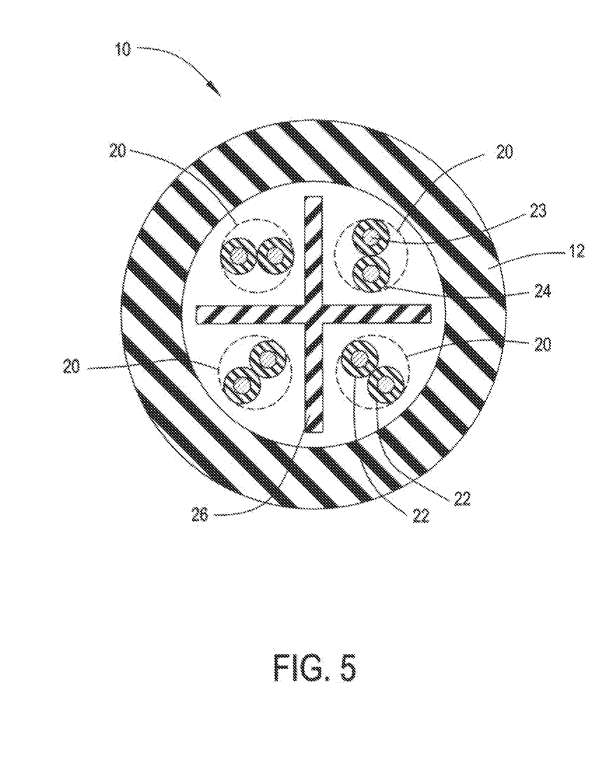

In one embodiment as illustrated in FIG. 5, a LAN (Local Area Network) cable 10 is shown. For the purposes of illustration, the salient features of the present arrangement are described in the context of twisted pairs of a LAN cable, however, the invention is not limited in this respect. Other cables with twisted pairs, such as typical two pair phone cable or even larger 25+ pair network cables may also employ the present technology.

As shown in FIG. 5, LAN cable 10 has a jacket 12 constructed for example from any typical jacket polymer such as PVC (Poly-Vinyl Chloride). Within jacket 12 there are four twisted pairs 20. Each twisted pair is formed of two primary conductors 22 twisted around one another. As shown in FIG. 5 primary conductors 22 are typically made from a copper wire conductor 23 covered with an insulation layer 24. The use of a four twisted pair LAN cable is for exemplary purposes. In FIG. 5, cable 10 is shown with a cross filler 26, but the salient features of the below described spacer element may be used in cables 10 with or without cross fillers 26.

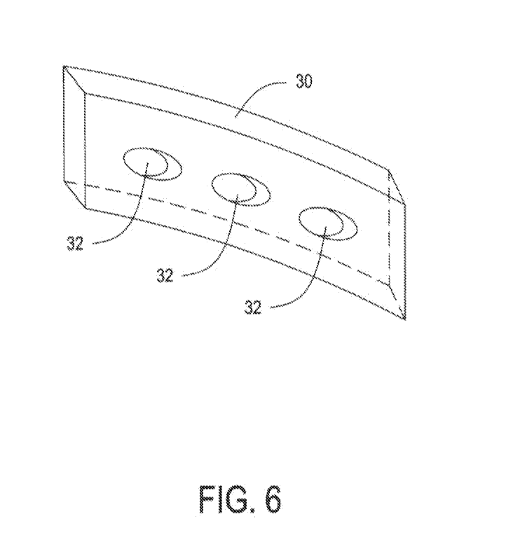

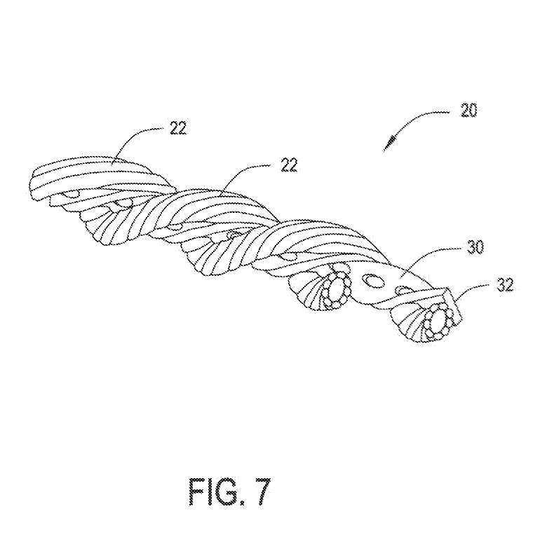

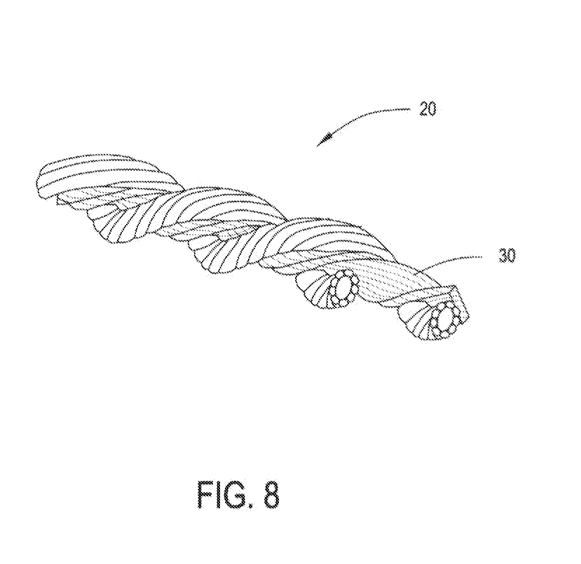

In one arrangement, as shown in FIG. 6 a spacer element 30 is provided. Spacer element 30 is formed as a longitudinal rectangular divider with openings 32. Spacer 30 roughly sized to match the size and dimensions of primary conductors 22 of a twisted pair 20. Spacer 30 is configured to be placed between primary conductors 22 during the twinning process that generates a twisted pair 20 as described in more detail below with respect to FIG. 7.

Returning to the dimensions of spacer 30, in one arrangement, spacer 30 is a tape having a thickness substantially between 0.005″ to 0.020″ with preferred thickness around 0.008″. The width of spacer 30 may be anywhere from 0.030″ to 0.060″ with preferred width about 0.045″. In one arrangement, if increased spacing between conductors 22 is desired, spacer 30 width can be doubled and then folded back over itself to yield a spacer twice as thick to increase insulated pair spacing. It is understood that such dimensions are exemplary and additional sizing may be used depending on the desired physical and electrical characteristics.

In one embodiment, openings 32 in spacer 30 may be circular, ovoid, square, rectangular, polygon shaped, or other such geometric shapes. For example, rectangular openings 32 could be about 0.040″ long and 0,020″ wide in a spacer 30 that is 0.008″ thick and 0.045″ wide. The distance between the center of the rectangular openings could be 0.080.″ This center to center distance can either be constant or variable along the length of spacer 30.

Turning to the material used for spacer 30, in one example, spacer 30 is made as a polymer tape. Any polymer with good electrical properties and mechanical toughness can be selected. Common examples of such materials could be but are not limited to UHMWPE, HDPE, PP, PEI, FEP, PTFE, MFA, PFA, and poly-aramids such as Nomex. These polymers could also contain additives to improve crush resistance or enhance flame performance.

In another arrangement, a polymer oven mesh tape (woven fabric constructed of polymer strands or polymers that are spun into fibers) may be used for spacer 30. These may include, but would not be limited to PP, PET, PEI, and poly-aramid (Kevlar). Such woven mesh polymer spacers 30 may be used in as desired for the light weight and crush resistance. For example, if a woven mesh tape is used for spacer 30, the thickness of the woven fibers and the distance between the fibers can vary. An example of this would be using fibers of 0.0025″ woven together with spacing of 0.0025″ between the fibers. It is understood that such dimensions are exemplary and additional/alternative opening sizing may be used depending on the desired physical and electrical characteristics,

It is noted that a reason for using spacer 30 is to increase dielectric separation between conductors 22 in pair 20. The air that fills openings 32 in spacer 30 has better dielectric properties than the polymer so such openings are ideally maximized. However, as discussed in more detail below, there is a practical limit to the number, shape and size of openings 32, in that spacer 30 must not only be constructed to have such openings 32, but there must be at least enough polymer in spacer 30 so that such openings are retained, at least to some desired extent, through the twinning process as explained in more detail below.

Turning to the placement of spacer 30 in between conductors 22 of pair 20, as shown in FIG. 7, spacer 30 may be pulled in between each individual wire pair 22 prior to entering the twinner (a machine that twists the pair at a given lay length/twist rate). FIG. 8 shows an alternative arrangement of spacer 30 as a woven mesh tape between conductors 22 of pair 20. For the purposes of illustrating the salient features below, the example of a polymer tape with openings 32 as shown in FIG. 7 is used.

The final lay length of twisted pair 20 incorporating spacer 30 would typically vary anywhere between 0.25″ to 1.00″ (longitudinal length per 1 full twist) depending on the construction. Modified closing dies may be utilized during twisting to maintain component positioning. It is understood that these measurements are for typical LAN cable applications, but spacer 30 in twinned pair 20 may be used at any desired lay length.

It is noted that spacer 30 is constructed, as outlined above, to both reduce the amount of material used (e.g. openings 32) as well as to resist crushing forces inherent to the twinning process. Twinning conductors 22 into pair 20 causes some amount of force to be applied against one another during twisting. With spacer 30 therebetween the force is exerted on spacer 30.

For example, the speed of the twist, dependent on the lay length and the electrical properties desired, is governed by a combination of bow speed and take up speed of the twisted pair containing the spacer onto the reel. An exemplary bow rotation speed could range anywhere from approximately 100 RPM to 3,000 RPM while the resulting take up speed of the twisted pair containing the spacer can vary anywhere from 20 FPM to 500 FPM. The desired lay length of twisted pair 20 containing spacer 30 between them governs both the bow rotation speed and the twisted pair take up speed. In any event the size of spacer 30 and the location, size and number of openings 32, are advantageously constructed such that the basic structure of spacer 30 and its spacing goal (desired space between conductors 22), and desired electrical characteristics are maintained during the twinning process.

In one arrangement, the material selected for spacer 30 has an impact on compression of spacer 30 during twinning, with for example a material like PEI being more resistant to compression than a material like PTFE. The twinning process also has a role in the amount of compression spacer 30 encounters, with bow speed and lay length being the critical factors. Depending on the material selected for spacer 30, the twinning process may be adjusted accordingly to minimize compression.

In all, the existence of spacer 30 and the inclusion and maintenance of openings 32, provides a lower cable cost due to reduction of material consumption. Additionally, reduction of insulated conductor 20 size may be achieved due to improved electrical properties realized by spacer 30. For example, the advantageous electrical properties of spacer 30 with openings 32 allows for insulated wires 20 in cables with excellent electrical properties to fit into existing connector arrangements which is a benefit for the end user. Moreover, reduction of the amount of insulation used for conductors 20 also leads to reduced overall cable size, another cable characteristic desired by end users.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A spacer for use in a twisted pair of electrical conductors said spacer comprising:
a polymer strip; and
a series of openings in said polymer strip,
wherein said polymer strip is configured to be placed between two adjacent conductors of a twisted pair,
and where said polymer strip and said series of openings are constructed so that said series of openings are not substantially crushed during a twinning process of twisting said adjacent conductors of said twisted pair.

2. The spacer as claimed in claim 1, wherein said spacer is rectangular in shape.

3. The spacer as claimed in claim 2, wherein said spacer is between 0.005″ to 0.020″ in thickness.

4. The spacer as claimed in claim 2 wherein said spacer is between 0.030″ to 0.060″

5. The spacer as claimed in claim 1, wherein said spacer is made from a polymer.

6. The spacer as claimed in claim 5, wherein said polymer is selected from the group consisting of UHMWPE, HDPE, PP, PEI, FEP, PTFE, MFA, PFA and poly-aramid.

7. The spacer as claimed in claim 1, wherein said spacer is made from a woven mesh of fibers.

8. The spacer as claimed in claim 7, wherein said woven mesh of fibers are made from polymer fibers that are spun into fibers including fibers of polymers selected from the group consisting of PP, PET, PET, and poly-aramid (Kevlar, Nomex).

9. The spacer as claimed in claim 7, wherein said woven mesh is made with fibers having substantially 0.0025″ distance between the fibers.

10. The spacer as claimed in claim 1, wherein said openings are in a shape selected from the group consisting of circular, ovoid, square, rectangular and polygon shapes.

11. The spacer as claimed in claim 10, wherein, when said openings are rectangular, said openings are substantially about 0.040″ long and 0.020″ wide, when said spacer is 0.008″ thick and 0.045″ wide.

12. The spacer as claimed in claim 11, wherein a distance between the center of the rectangular openings is substantially 0.080 along the length said spacer.

13. The spacer as claimed in claim 1, wherein said openings in said spacer are filled with air.

14. The spacer as claimed in claim 13, wherein said spacer is constructed of a material and wherein said openings are of a size, shape and dimension, that said openings substantially retain their form during twinning of said conductors so as to maintain the air dielectric in said openings.
